(19) United States
(12) Patent Application Publication
(10) Pub. No.: US 2025/0356837 A1
(43) Pub. Date: Nov. 20, 2025

(54) METHOD AND APPARATUS FOR EDITING AUDIO CONTENT, ELECTRONIC DEVICE, AND PRODUCT

(71) Applicants: Beijing Zitiao Network Technology Co., Ltd., Beijing (CN); Lemon Inc., Grand Cayman (KY)

(72) Inventors: Dongya JIA, Beijing (CN); Jian CONG, Beijing (CN); Zhuo CHEN, Los Angeles, CA (US); Yuanzhe CHEN, Beijing (CN); Zhengxi LIU, Beijing (CN); Jiawei CHEN, Beijing (CN); Yuping WANG, Beijing (CN); Yuxuan WANG, Los Angeles, CA (US)

(21) Appl. No.: 19/207,188

(22) Filed: May 13, 2025

(30) Foreign Application Priority Data
May 15, 2024 (CN) 202410605604.2

(51) Int. Cl. G10L 13/033; G10L 13/027; G10L 13/08

(52) U.S. Cl. CPC G10L 13/033; G10L 13/027; G10L 13/08

(57) ABSTRACT

Embodiments of the present disclosure relate to a method and apparatus for editing audio content, a device, and a product. The method further includes acquiring a modified text, where the modified text includes an original portion identical to an original text of the original audio and a modified portion different from the original text. The method further includes generating, based on the modified text and an original acoustic feature, a target acoustic feature corresponding to the modified portion of the modified text using a self-attention-based diffusion model. Additionally, the method further includes generating a target audio based on the original acoustic feature and the target acoustic feature.

### CROSS-REFERENCE TO RELATED APPLICATION(S)

This application claims priority to Chinese Application No. 202410605604.2 filed on May 15, 2024, the disclosure of which is incorporated herein by reference in its entirety.

### FIELD

The present disclosure generally relates to the field of artificial intelligence, and more specifically, to a method and apparatus for editing audio content, an electronic device, and a medium.

### BACKGROUND

Text-to-speech is a technology that provides a written text and then generates a corresponding speech based on the text. The technology is widely applied to various scenarios, such as smart assistants, audiobook narration for e-books, vehicle navigation systems, and customer services. In some scenarios, content of audio needs to be edited. A user may modify a text of the audio, and then generate audio corresponding to the modified text.

### SUMMARY

Embodiments of the present disclosure provide a method and apparatus for editing audio content, an electronic device, and a product.

In a first aspect of the embodiments of the present disclosure, a method for editing an audio is provided. The method includes determining an original acoustic feature of an original audio. The method further includes acquiring a modified text, where the modified text includes an original portion identical to an original text of the original audio and a modified portion different from the original text. The method further includes generating, based on the modified text and the original acoustic feature, a target acoustic feature corresponding to the modified portion of the modified text using a self-attention-based diffusion model. Additionally, the method further includes generating a target audio based on the original acoustic feature and the target acoustic feature.

In a second aspect of the embodiments of the present disclosure, an apparatus for editing an audio is provided. The apparatus includes an original feature determination module, configured to determine an original acoustic feature of an original audio. The apparatus further includes a modified text acquiring module, configured to acquire a modified text, where the modified text includes an original portion identical to an original text of the original audio and a modified portion different from the original text. The apparatus further includes a target feature generation module, configured to generate, based on the modified text and the original acoustic feature, a target acoustic feature corresponding to the modified portion of the modified text using a self-attention-based diffusion model. Additionally, the apparatus further includes a target audio generation module, configured to generate a target audio based on the original acoustic feature and the target acoustic feature.

In a third aspect of the embodiments of the present disclosure, an electronic device is provided. The electronic device includes one or more processors; and a storage apparatus, configured to store one or more programs. The one or more programs, when executed by the one or more processors, cause the one or more processors to implement a method for editing audio content. The method includes determining an original acoustic feature of an original audio. The method further includes acquiring a modified text, where the modified text includes an original portion identical to an original text of the original audio and a modified portion different from the original text. The method further includes generating, based on the modified text and the original acoustic feature, a target acoustic feature corresponding to the modified portion of the modified text using a self-attention-based diffusion model. Additionally, the method further includes generating a target audio based on the original acoustic feature and the target acoustic feature.

In a fourth aspect of the embodiments of the present disclosure, a computer program product is provided. The computer program product is tangibly stored on a non-transitory computer-readable medium and includes machine-executable instructions, and the machine-executable instructions, when executed, cause a machine to implement a method for editing audio content. The method includes determining an original acoustic feature of an original audio. The method further includes acquiring a modified text, where the modified text includes an original portion identical to an original text of the original audio and a modified portion different from the original text. The method further includes generating, based on the modified text and the original acoustic feature, a target acoustic feature corresponding to the modified portion of the modified text using a self-attention-based diffusion model. Additionally, the method further includes generating a target audio based on the original acoustic feature and the target acoustic feature.

The section SUMMARY is provided to introduce concept selection in a simplified form, which will be further described in the following specific implementations. The section SUMMARY is not intended to identify key or essential features of the subject claimed for protection, nor is it intended to limit the scope of the subject claimed for protection.

### BRIEF DESCRIPTION OF THE DRAWINGS

The above-mentioned and other features, advantages, and aspects of various embodiments of the present disclosure will become more apparent in conjunction with the accompanying drawings and with reference to following detailed descriptions. In the accompanying drawings, the same or similar reference numerals denote the same or similar elements.

FIG. 1 illustrates a schematic diagram of an example environment where some embodiments of the present disclosure may be implemented;

FIG. 2 illustrates a flowchart of a method for editing audio content according to some embodiments of the present disclosure;

FIG. 3 illustrates a schematic diagram of an example process for editing audio content using a self-attention-based diffusion model in an inference phase according to some embodiments of the present disclosure;

FIG. 4 illustrates a schematic diagram of an example architecture of a self-attention-based diffusion model according to some embodiments of the present disclosure;

FIG. 5 illustrates a schematic diagram of an example process for training a self-attention-based diffusion model in a training phase according to some embodiments of the present disclosure;

FIG. 6 illustrates a block diagram of an apparatus for editing audio content according to some embodiments of the present disclosure; and

FIG. 7 is a block diagram of an electronic device according to some embodiments of the present disclosure.

In all the accompanying drawings, the same or similar reference numerals denote the same or similar elements.

### DETAILED DESCRIPTION OF EMBODIMENTS

It should be understood that data (including but not limited to the data itself, and data acquisition, or usage) involved in the technical solutions should comply with the requirements of corresponding laws and regulations, and relevant stipulations.

It should be understood that before the use of the technical solutions disclosed in the embodiments of the present disclosure, a user shall be informed of the type, range of use, use scenarios, etc., of personal information involved in the present disclosure in an appropriate manner in accordance with relevant laws and regulations, and the authorization of the user shall be obtained.

For example, when an active request from the user is received, a prompt message is sent to the user to clearly prompt the user that an operation requested to be performed will require access to and use of the personal information of the user. As such, the user can independently choose, according to the prompt message, whether to provide the personal information to software or hardware, such as an electronic device, an application, a server, or a storage medium, that performs the operations of the technical solutions of the present disclosure.

As an optional but non-limiting implementation, in response to the reception of the active request from the user, the method for sending the prompt information to the user may be, for example, a pop-up window, in which the prompt message may be presented in text. Additionally, the pop-up window may also carry a selection control for the user to choose whether to “agree” or “disagree” to provide the personal information to the electronic device.

It should be understood that the above-mentioned notification and user authorization obtaining process is only illustrative, which does not limit the implementations of the present disclosure, and other methods that comply with the relevant laws and regulations may also be applied to the implementations of the present disclosure.

The embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. On the contrary, these embodiments are provided for a more thorough and complete understanding of the present disclosure. It should be understood that the accompanying drawings and the embodiments of the present disclosure are for exemplary purposes only, and are not intended to limit the scope of protection of the present disclosure.

In the description of the embodiments of the present disclosure, the term “include” and similar terms thereof should be understood as open-ended inclusions, namely, “including but not limited to”. The term “based on” should be understood as “at least partially based on”. The term “an embodiment” or “this embodiment” should be understood as “at least one embodiment”. The terms “first”, “second”, etc. may refer to different or identical objects, unless otherwise explicitly specified. Additional explicit and implicit definitions may also be included below.

As described above, in some scenarios, content of audio needs to be edited. A user may modify a text of the audio, and then generate audio corresponding to the modified text. In this scenario, a conventional text-to-speech technology falls short because the technology cannot adapt to original timbre of the audio and cannot control the length of the generated audio, and as a result, the length of the edited audio changes. If the audio originates from a video clip, audio content and video content may be misaligned.

When recording audio and a video, a speaker may make mistakes during speech. For example, the speaker intends to say, “The weather is truly awful today”, but accidentally say, “The weather is truly wonderful today” In this case, the audio or video needs to be recorded again from the beginning, or a portion of the audio or video needs to be recorded again, and then an editing application is used to replace an erroneous segment, which is time-consuming, and may also result in an incoherent or unnatural phenomenon in the edited audio or video. In some related art, the user may modify a portion of text content in subtitles of an original audio and then regenerate new audio based on a modified text. Therefore, the user can complete audio content editing with just a few simple steps of operations. However, in the related art, the authenticity of an audio segment in the generated audio corresponding to the modified text is relatively low, and the timbre of the segment differs significantly from that of unmodified portions, making it easy for listeners to identify that the audio has been machine-processed, and as a result, user experience is reduced.

In view of this, an embodiment of the present disclosure provides a solution for editing audio content using a self-attention-based diffusion model. In the solution, an original acoustic feature of an original audio may be determined, and a modified text is acquired. The modified text includes an original portion identical to an original text of the original audio and a modified portion different from the original text. Then, in the solution, based on the modified text and the original acoustic feature, a modified acoustic feature corresponding to the modified portion of the modified text may be generated using the self-attention-based diffusion model. Then, in the solution, edited audio may be generated based on the original acoustic feature and the modified acoustic feature.

In the example described above, for the original audio with the content “The weather is truly wonderful today”, the text content “wonderful” may be modified to “awful”. By using the solution provided in this embodiment of the present disclosure, the audio with the content “The weather is truly awful today” can be generated, with the timbre being consistent with that of the original audio, and an unmodified portion (including content, timbre, and occurrence time within the entire audio, etc.) remaining unchanged. It should be noted that the timbre involved in this embodiment of the present disclosure is an existing timbre in a timbre library or a timbre authorized for use.

In this way, the authenticity of the audio corresponding to the modified portion of the text can be improved, and timbre similarity between the audio of the modified portion and the original audio can also be improved. Accordingly, the listener is unable to perceive that a portion of the audio has been machine-processed when listening to the audio, which can save time spent on audio editing without reducing the user experience of the listener. Additionally, a duration of the modified audio portion generated through this method remains consistent with a duration of the portion before modification, thereby reducing misalignment between the edited audio and a video scene.

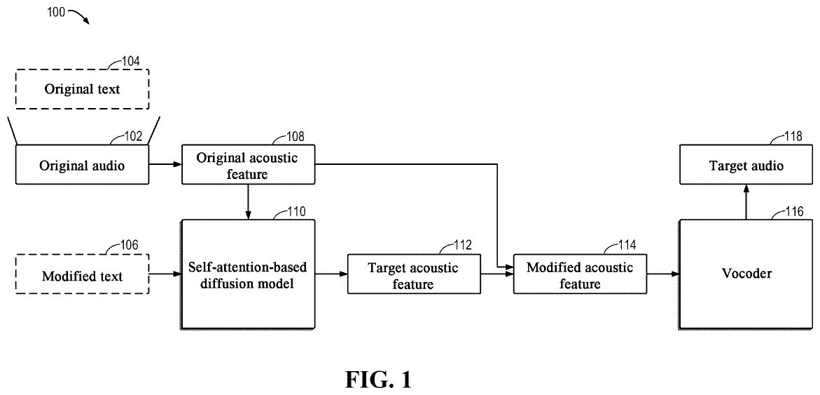

FIG. 1 illustrates a schematic diagram of an example environment 100 where some embodiments of the present disclosure may be implemented. As shown in FIG. 1, the environment 100 includes original audio 102, and content of the original audio 102 may include an original text 104. For example, the original audio 102 may be an audio clip acquired from a segment of video, and the audio clip includes a speaker statement, “The weather is truly wonderful today” (i.e., the original text 104). The environment 100 further includes a modified text 106, and the modified text 106 is a text obtained after modifying part of the content in the original audio 102. For example, the user is intended to replace “wonderful” with “awful” in the original audio 102, and therefore the content of the original audio 102 is modified to “The weather is truly awful today”. The user may perform modification based on the original text 104, thereby generating the modified text 106 (i.e., “The weather is truly awful today”).

In the environment 100, an original acoustic feature 108 may be extracted from the original audio 102. The acoustic feature may refer to various physical and perceptual attributes of sound. For example, the acoustic feature may refer to timbre, clarity, loudness, rhythm, and speed of an audio signal. In the environment 100, the acoustic feature may be a feature extracted through various methods, such as a feature extracted through a Mel vocoder, a feature extracted through an audio variational autoencoder (VAE), and a feature extracted through SoundStream.

After extracting the original acoustic feature 108 from the original audio 102, a target acoustic feature 112 may be generated using a self-attention-based diffusion model 110 based on the original acoustic feature 108 and the modified text 106. The target acoustic feature 112 corresponds to a modified portion in the modified text 106 and has the same timbre as the original audio 102. For example, if the modified portion in the modified text 106 is “awful”, the target acoustic feature 112 is an acoustic feature corresponding to “awful”.

A diffusion model is a generative model, which is often used for an image generation task. A generation process of the diffusion model includes a forward process and a reverse process. In the forward process, noise is added to data to make the data more random, and in the reverse process, a trained model is used to perform multi-time noise reduction on noised data to restore clean data. By using the diffusion model, high-quality data with rich details can be generated.

A Transformer model is a representative of a self-attention mechanism. The self-attention mechanism may calculate an attention score of each element in a sequence for other elements, and based on the attention scores, which parts of an input sequence should be given more attention may be determined when generating each output element. The self-attention mechanism allows the model to simultaneously consider all the elements within the sequence when processing data, thereby causing the model to capture a long-range dependency relationship in the data.

By combining a generative capability of the diffusion model with the self-attention mechanism from a Transformer architecture, the self-attention-based diffusion model 110 may use contextual information of the entire original acoustic feature 108 to generate the target acoustic feature 112 in the generation process. Therefore, the accuracy and authenticity of the generated target acoustic feature 112, as well as the timbre similarity relative to the original audio 102 can be improved.

In the environment 100, after generating the target acoustic feature 112, a modified acoustic feature 114 may be generated based on the original acoustic feature 108 and the target acoustic feature 112. For example, the target acoustic feature 112 may be used to replace the modified portion in the original acoustic feature 108. For example, the generated target acoustic feature 112 corresponding to “awful” may be used to replace the acoustic feature in the original acoustic feature 108 corresponding to “wonderful”, thereby generating the modified acoustic feature 114.

In the environment 100, a vocoder 116 may reconstruct an audio signal by using the acoustic feature. After generating the modified acoustic feature 114, the vocoder 116 may generate a target audio 118 based on the modified acoustic feature 114. In the target audio 118, the modified portion is replaced with model-generated audio, with the timbre being consistent with that of the original audio 102 and an unmodified portion remaining unchanged.

In this way, the authenticity of the modified portion in the generated target audio 118 can be improved, and timbre similarity between the audio of the modified portion and the original audio can also be improved. Accordingly, the listener is unable to perceive that a portion of the audio has been machine-processed when listening to the target audio 118, which can save time spent on audio editing without reducing the user experience.

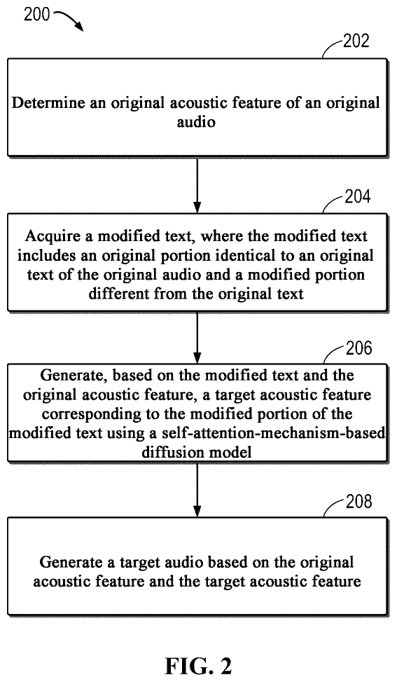

The process according to this embodiment of the present disclosure will be described in detail in conjunction with FIG. 2 to FIG. 7 below. For ease of understanding, specific data mentioned in the following description is exemplary and is not intended to limit the scope of protection of the present disclosure. It should be understood that the embodiments described below may also include additional actions not shown and/or may omit shown actions, and the scope of the present disclosure is not limited in this aspect.

FIG. 2 illustrates a flowchart of a method 200 for editing audio content according to some embodiments of the present disclosure. At a block 202, in the method 200, an original acoustic feature of an original audio may be determined. For example, in the environment 100 shown in FIG. 1, the original acoustic feature 108 of the original audio 102 may be determined, and the original acoustic feature 108 may include information such as timbre of the original audio 102. For example, content of the original audio 102 may be “The weather is truly wonderful today”.

At a block 204, in the method 200, a modified text may be acquired, where the modified text includes an original portion identical to an original text of the original audio and a modified portion different from the original text. For example, in the environment 100 shown in FIG. 1, the modified text 106 may be acquired and may be generated by modifying the original text 104. For example, the original text 104 may be “The weather is truly wonderful today”, and the modified text 106 may be “The weather is truly awful today”, where “awful” in the modified text 106 is a modified portion different from the original text 104, and “The weather is truly” is the original portion identical to the original text 104.

At a block 206, in the method 200, based on the modified text and the original acoustic feature, a target acoustic feature corresponding to the modified portion of the modified text may be generated using an attention-mechanism-based diffusion model. For example, in the environment 100 shown in FIG. 1, the self-attention-based diffusion model 110 may generate the target acoustic feature 112 based on the modified text 106 and the original acoustic feature 108, where the target acoustic feature 112 corresponds to the modified portion in the modified text 106 and has the same timbre as the original audio 102. For example, if the modified portion in the modified text 106 is “awful”, the target acoustic feature 112 is an acoustic feature corresponding to “awful”.

At a block 208, in the method 200, a target audio may be generated based on the original acoustic feature and the target acoustic feature. For example, in the environment 100 shown in FIG. 1, the modified acoustic feature 114 may be generated based on the original acoustic feature 108 and the target acoustic feature 112. In the modified acoustic feature 114, the modified portion may be the target acoustic feature 112, and the unmodified portion may be a corresponding portion in the original acoustic feature 108. Then, the vocoder 116 may generate the target audio 118 based on the modified acoustic feature 114. In the target audio 118, the modified portion is replaced with model-generated audio, with the timbre being consistent with that of the original audio 102 and an unmodified portion remaining unchanged.

In this way, the authenticity of the modified portion in the generated target audio can be improved, and timbre similarity between the audio of the modified portion and the original audio can also be improved. Accordingly, the listener is unable to perceive that a portion of content of the audio has been machine-processed when listening to the target audio, which can save time spent on audio editing without reducing the user experience.

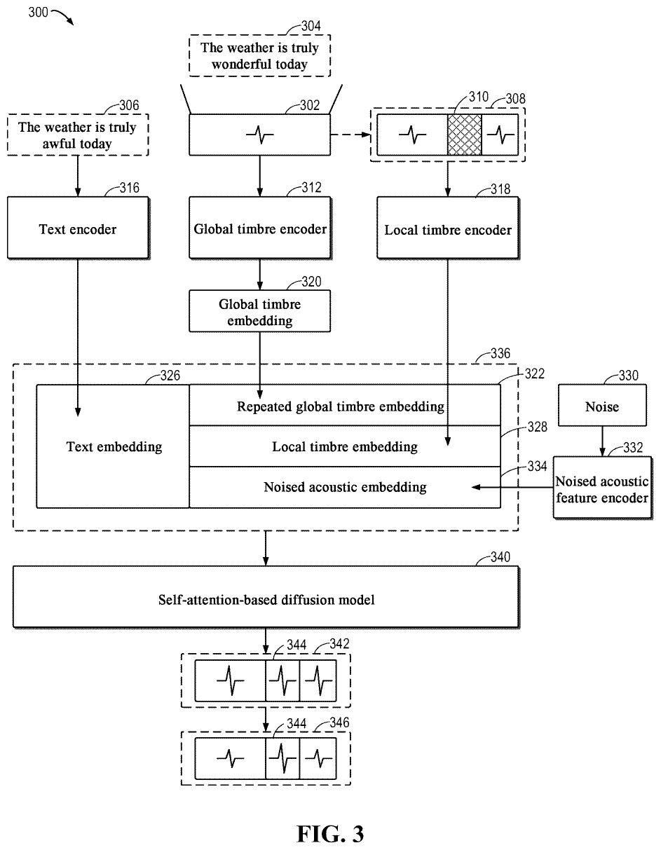

FIG. 3 illustrates a schematic diagram of an example process 300 for editing audio content using a self-attention-based diffusion model in an inference phase according to some embodiments of the present disclosure. As shown in FIG. 3, in the process 300, an original acoustic feature 302 is included, and is extracted from an original audio with content being an original text 304 (e.g., “The weather is truly wonderful today”). In the process 300, a modified text 306 (e.g., “The weather is truly awful today”) is further included, and the modified text 306 is generated by modifying “wonderful” from the original text 304 to “awful”.

In some embodiments, to generate the target acoustic feature, a masked original acoustic feature may be generated by masking an acoustic feature in the original acoustic feature that corresponds to the modified portion. Then, the target acoustic feature may be generated based on the modified text, the original acoustic feature, and the masked original acoustic feature. For example, as shown in FIG. 3, in the process 300, an acoustic feature corresponding to “wonderful” in the original acoustic feature 302 may be masked, to generate a masked original acoustic feature 308. In the masked original acoustic feature 308, an acoustic feature 310 is a masked portion, and values of the masked portion may all be set to certain values (e.g., 0, 1, or any other arbitrary value). Then, in the process 300, the target acoustic feature may be generated based on the modified text 306, the original acoustic feature 302, and the masked original acoustic feature 308. In this way, content of an unmodified portion in the masked original acoustic feature 308 can remain unchanged. Additionally, a duration (i.e., a duration of the acoustic feature 310) of the target acoustic feature to be generated can also be fixed, thereby ensuring the unchanged duration of the modified audio.

In some embodiments, a modified text embedding may be generated using a text encoder based on the modified text, a global timbre embedding is generated using a global timbre encoder based on global information of the original acoustic feature, and a local timbre embedding is generated using a local timbre encoder based on local information of the masked original acoustic feature. Then, the target acoustic feature may be generated based on the modified text embedding, the global timbre embedding, and the local timbre embedding. For example, as shown in FIG. 3, the text encoder 316 may generate a text embedding 326 based on the modified text 306, and a size of the text embedding 326 is [T1, C], where T1 represents a length of the modified text 306, C represents a specific vector dimension, and [T1, C] may represent T1 vectors, each with a dimension of C. The text encoder 316 has consistent input and output lengths, with a model structure being a convolutional neural network with padding. The padding may make an input size and an output size of a convolutional layer the same, and can avoid information losses. Additionally, the text encoder 316 may also be a Transformer.

As shown in FIG. 3, a global timbre encoder 312 may generate a global timbre embedding 320 based on global information of the original acoustic feature 302. The global information refers to all information of the acoustic feature. In some embodiments, when generating the global timbre embedding 320, the global timbre embedding 320 may be generated by taking the original acoustic feature 302 as a whole in a time dimension, and the size of the generated original acoustic feature 302 is [1, C]. In this way, global-scale information can be added for the generation of the target acoustic feature, thereby enriching an information scale in the generation process, and increasing the authenticity and timbre similarity of the generated acoustic feature.

An input of the global timbre encoder 312 is a segment of acoustic feature, an output is a vector without a time dimension (or may also be understood as a time dimension of 1), and an ECAPA-TDNN structure may be used to implement the global timbre encoder 312. ECAPA-TDNN is a neural network structure that incorporates an attention mechanism based on a time-delay neural network (TDNN). By using the structure for implementing the global timbre encoder 312, the global timbre encoder 312 can effectively learn feature dependency relationships in the time dimension, and can improve a feature representation capability by dynamically adjusting the importance of features across different channels, thereby capturing speech features in different time scales and enhancing a capability of the encoder in recognizing a speech mode.

As shown in FIG. 3, a local timbre encoder 318 may generate a local timbre embedding 328 based on local information of the masked original acoustic feature 308. The local information refers to information about a portion of feature within the acoustic feature, such as an acoustic feature corresponding to one or some of all audio frames. In some embodiments, when generating the local timbre embedding 328, the masked original acoustic feature 308 may be split into a plurality of local acoustic features according to the time dimension, and then the local timbre embedding 328 may be generated based on the plurality of local acoustic features. A size of the generated local timbre embedding 328 is [T2, C], where T2 represents a length of the acoustic feature (or may also be understood as T2 units of time), and [T2, C] may represent T2 vectors, each with a dimension of C. The local timbre encoder 318 may include, for example, one or more fully connected layers to ensure that the generated embedding has a dimension of C. In this way, the masked original acoustic feature 308 is split into T2 local acoustic features, a corresponding timbre embedding is generated for each local acoustic feature and is combined into the local timbre embedding 328, and local-scale information can be added for the generation of the target acoustic feature, thereby enriching the information scale in the generation process, and increasing the authenticity and timbre similarity of the generated acoustic feature.

In some embodiments, when generating the target acoustic feature, a random noise may be generated, and then, based on the random noise, a noised acoustic embedding is generated using a noised acoustic feature encoder. Then, a fused acoustic embedding may be generated by summing the global timbre embedding, the local timbre embedding, and the noised acoustic embedding. Then, a fused multimodal embedding may be generated by concatenating the fused acoustic embedding with the modified text embedding. Then, based on the fused multimodal embedding, the target acoustic feature may be generated using the self-attention-based diffusion model.

As shown in FIG. 3, noise 330 is randomly generated pure noise. A noised acoustic feature encoder 332 may generate a noised acoustic embedding 334 based on the noise 330. The noised acoustic feature encoder 332 may include, for example, one or more fully connected layers to ensure that the generated embedding has a dimension of C. As mentioned above, the size of the global timbre embedding 320 is [1, C], and to fuse the global timbre embedding 320 with other embeddings, the global timbre embedding 320 may be repeated T2 times in the time dimension, to generate a repeated global timbre embedding 322 with a size of [T2, C]. Then, in the process 300, a fused acoustic embedding with a size of [T2, C] may be generated by summing the repeated global timbre embedding 322, the local timbre embedding 328, and the noised acoustic embedding 334 and is concatenated with the text embedding 326 in time, to generate a fused multimodal embedding 336. Then, in the process 300, the target acoustic feature may be generated based on the fused multimodal embedding 336. In this way, the fused multimodal embedding 336 can fuse information from a plurality of modalities (i.e., text and speech), as well as a plurality of scales within the same modality (i.e., global timbre and local timbre), thereby providing richer information for the generative model, and improving the authenticity and timbre similarity of the generated acoustic feature.

In some embodiments, based on the fused multimodal embedding, a predicted acoustic feature may be generated using the self-attention-based diffusion model. The predicted acoustic feature includes a predicted original portion corresponding to the original portion of the modified text and a predicted modified portion corresponding to the modified portion of the modified text, and then the predicted modified portion may be determined as the target acoustic feature. As shown in FIG. 3, in the process 300, a self-attention-based diffusion model 340 may generate a predicted acoustic feature 342 based on the fused multimodal embedding 336, and the predicted acoustic feature 342 has content of the modified text 306, and maintains the timbre the same as that of the original acoustic feature 302. In the process 300, an acoustic feature 344 in the predicted acoustic feature 342 corresponds to the masked acoustic feature 310 in the masked original acoustic feature 308. In the process 300, the acoustic feature 344 may be determined as the target acoustic feature. Then, in the process 300, the acoustic feature 344 may be used to replace a masked portion (i.e., a portion corresponding to the modified portion of the modified text 306) in the masked original acoustic feature 308, thereby generating a modified original acoustic feature 346. In the modified original acoustic feature 346, an acoustic feature corresponding to the modified portion of the modified text 306 is replaced with the acoustic feature 344, while an unmodified original portion remains unchanged. Then, in the process 300, a target audio may be generated based on the modified original acoustic feature 346, namely audio with content being “The weather is truly awful today” and with the same timbre as that of the original audio. In this way, the authenticity of the generated target audio can be improved, and timbre similarity between the audio of the modified portion and the original audio can also be improved.

As mentioned above, in some embodiments, the self-attention-based diffusion model includes a plurality of self-attention blocks connected in series, and a portion of the plurality of self-attention blocks are connected to subsequent self-attention blocks that are spaced one or more self-attention blocks apart.

The self-attention-based diffusion model may integrate a generative capability of the diffusion model with a self-attention mechanism from a Transformer architecture. In some embodiments, the self-attention-based diffusion model includes a plurality of self-attention blocks connected in series, and a portion of the plurality of self-attention blocks are connected to subsequent self-attention blocks that are spaced one or more self-attention blocks apart.

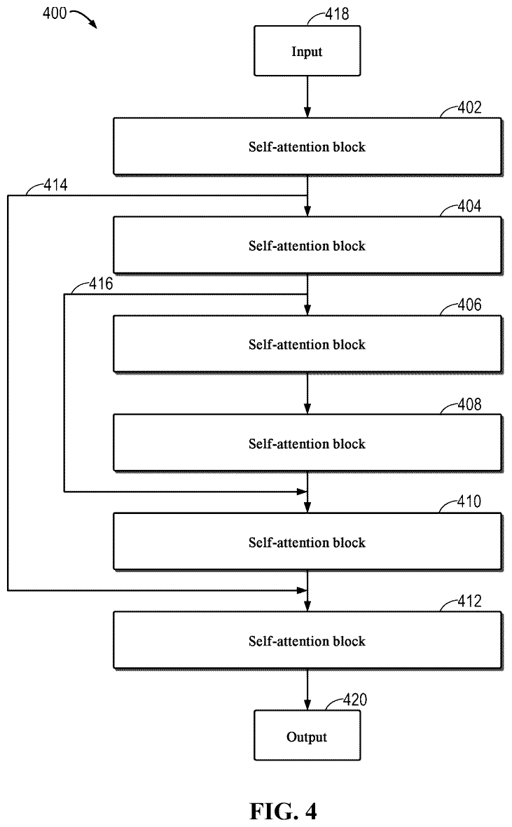

FIG. 4 illustrates a schematic diagram of an example architecture 400 of a self-attention-based diffusion model according to some embodiments of the present disclosure. As shown in FIG. 4, the architecture 400 includes self-attention blocks 402, 404, 406, 408, 410, and 412, and each self-attention block may have a Transformer architecture. In the architecture 400, these self-attention blocks are connected in series. That is, an output of each self-attention block located above serves as at least a portion of an input to its adjacent self-attention block below. The architecture 400 further includes a plurality of skip connections. For example, the output of the self-attention block 402 is connected to the self-attention block 412 via the skip connection 414, and the output of the self-attention block 404 is connected to the self-attention block 410 via the skip connection 416.

In the architecture 400, the self-attention-based diffusion model receives an input 418 and generates an output 420. The architecture 400 inputs the input 418 into the self-attention block 402. Each self-attention block may independently process input data and use the Transformer architecture to extract and learn high-level features. The self-attention mechanism can process global information across an entire input sequence, thereby allowing the model to better understand and represent a complex mode and a relationship within the input 418. The serial connection between the self-attention blocks allows the information to flow from top to bottom within the model. Each block may further process and refine features based on the previous block, and the method can gradually enhance a data representation capability.

The skip connections in the architecture 400 can allow information from previous blocks not to be forgotten by subsequent blocks, thereby alleviating a vanishing gradient problem in an architecture network. Additionally, these skip connections can also facilitate the rapid propagation of the features, aiding in the direct transmission of key information between various blocks, which can improve the efficiency and stability of the model.

In the training phase, both the modified text and the original acoustic feature may originate from the same sentence. In some embodiments, a portion of the original acoustic feature may be randomly masked. A masked portion is a portion that the model needs to predict, while the remaining portion may serve as a prompt. In some embodiments, a training process of the self-attention-based diffusion model includes determining a training acoustic feature of a training audio, where the training audio corresponds to a training text. A masked training acoustic feature may be generated by masking a portion of the training acoustic feature. Then, the self-attention-based diffusion model is trained based on the training text, the training acoustic feature, and the masked training acoustic feature. In some embodiments, a noised training acoustic feature may be generated by adding noise to the training acoustic feature. Then, a predicted masked acoustic feature may be generated by denoising the noised training acoustic feature based on the training text and the masked training acoustic feature. Then, the self-attention-based diffusion model may be trained based on the predicted masked acoustic feature and the training acoustic feature.

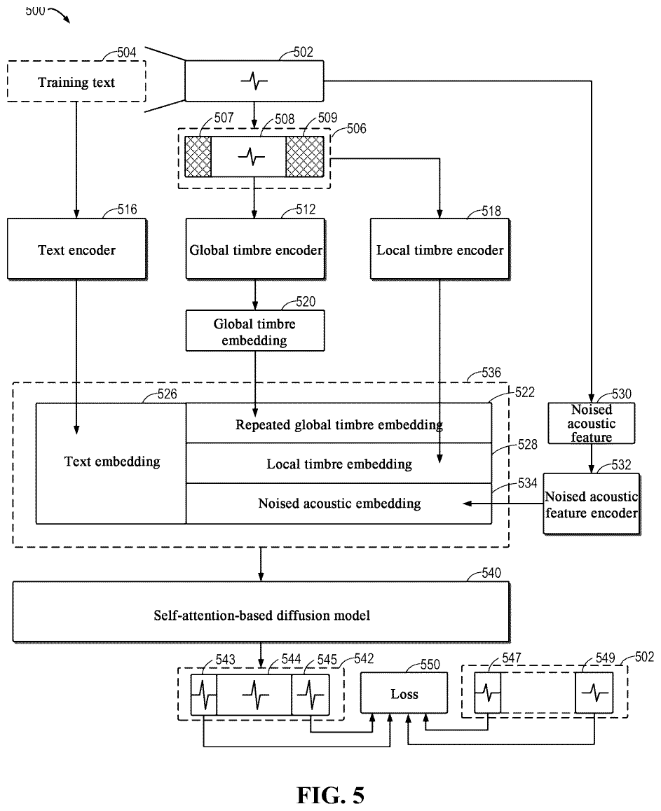

FIG. 5 illustrates a schematic diagram of an example process 500 for training a self-attention-based diffusion model in a training phase according to some embodiments of the present disclosure. As shown in FIG. 5, in the process 500, content of an original acoustic feature 502 is a training text 504. In the process 500, a portion of the original acoustic feature 502 may be randomly masked, thereby generating a masked original acoustic feature 506. In the masked original acoustic feature 506, acoustic features 507 and 509 are masked portions, values of the masked portions may all be set to certain values (e.g., 0, 1, or any other arbitrary value), and an acoustic feature 508 is an unmasked portion.

In the process 500, a text encoder 516, which may be, for example, the text encoder 316 in FIG. 3, may generate a text embedding 526 based on the training text 504, and a size of the text embedding 526 is [T1, C]. Additionally, a global timbre encoder 512, which may be, for example, the global timbre encoder 312 in FIG. 3, may generate a global timbre embedding 520 with a size of [1, C] based on an unmasked portion (i.e., the acoustic feature 508) in the masked acoustic feature 506. The reason for generating the global timbre embedding 520 based on the acoustic feature 508 rather than the original acoustic feature 502 is that the original acoustic feature 502 includes a true acoustic feature of the masked portion. If the original acoustic feature 502 is used to generate the global timbre embedding 520, it is easier for the model to predict true values of the masked acoustic features 507 and 509, and as a result, a predictive capability of the model will be reduced. Accordingly, generating the global timbre embedding 520 only based on the unmasked acoustic feature 508 can enhance the predictive capability of the model. In the process 500, a local timbre encoder 518, which may be, for example, the local timbre encoder 318 in FIG. 3, may generate a local timbre embedding 528 with a size of [T2, C] based on the masked original acoustic feature 506.

As shown in FIG. 5, in the process 500, noise may be added to the original acoustic feature 502 to generate a noised acoustic feature 530, and the noised acoustic feature 530 may be used to be restored into a predicted original acoustic feature in a denoising process. In the process 500, a noised acoustic feature encoder 532 may be, for example, the noised acoustic feature encoder 332 in FIG. 3. The noised acoustic feature encoder 532 may generate a noised acoustic embedding 534 based on the noised acoustic feature 530.

In the process 500, the global timbre embedding 520 may be repeated T2 times in the time dimension, to generate a repeated global timbre embedding 522 with a size of [T2, C]. Then, in the process 300, a fused acoustic embedding with a size of [T2, C] may be generated by summing the repeated global timbre embedding 522, the local timbre embedding 528, and the noised acoustic embedding 534 and is concatenated with the text embedding 526 in time, to generate a fused multimodal embedding 536.

In the process 500, a self-attention-based diffusion model 540 may be, for example, the self-attention-based diffusion model 340 in FIG. 3. The self-attention-based diffusion model 540 may generate a predicted acoustic feature 542 based on the fused multimodal embedding 536. The predicted acoustic feature 542 includes a prediction of the masked acoustic features 507 and 509 in the masked original acoustic feature 506 (i.e., predicted acoustic features 543 and 545) and a prediction of the unmasked acoustic feature 508 (i.e., an acoustic feature 544).

In the process 500, true values 547 and 549 of acoustic features of a masked portion may be extracted from the original acoustic feature 502. Then, a loss function such as an L1 loss function or an L2 loss function may be used to calculate a loss 550 between the predicted acoustic features 543 and 545 and the true values 547 and 549, and the self-attention-based diffusion model 540 is trained by minimizing a value of the loss 550.

By randomly masking a portion of the original acoustic feature and calculating the loss between predicted values and the true values of the masked portion, the model can be allowed to learn how to infer missing data based on contextual information of the original acoustic feature. In the training process, a case of predicting the acoustic feature of the modified portion in the modified text in an inference task can be simulated, thereby allowing the model to be more adaptive to different input cases, and demonstrate improved performance when facing unknown or incomplete data.

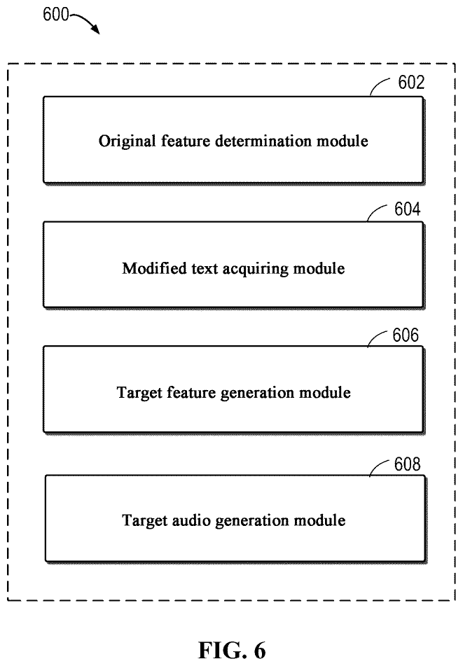

FIG. 6 illustrates a block diagram of an apparatus 600 for editing audio content according to some embodiments of the present disclosure. As shown in FIG. 6, the apparatus 600 includes an original feature determination module 602, configured to determine an original acoustic feature of an original audio. The apparatus 600 further includes a modified text acquiring module 604, configured to acquire a modified text, where the modified text includes an original portion identical to an original text of the original audio and a modified portion different from the original text. The apparatus 600 further includes a target feature generation module 606, configured to generate, based on the modified text and the original acoustic feature, a target acoustic feature corresponding to the modified portion of the modified text using a self-attention-based diffusion model. Additionally, the apparatus 600 further includes a target audio generation module 608, configured to generate a target audio based on the original acoustic feature and the target acoustic feature.

It should be understood that by using the apparatus 800 in the present disclosure, at least one of the many advantages capable of being implemented in the methods or the processes described above may be achieved. For example, the apparatus 800 can improve the authenticity of the audio corresponding to the modified portion of the text, and also improve timbre similarity between the audio of the modified portion and the original audio.

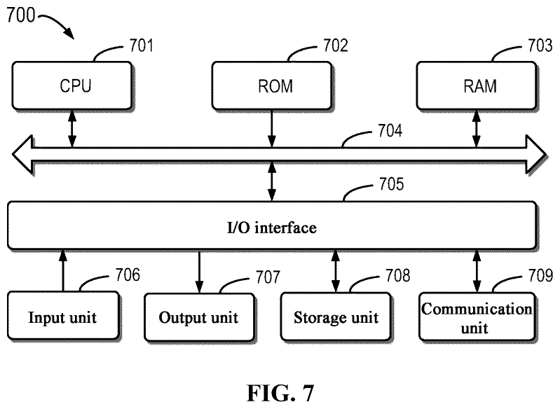

FIG. 7 illustrates a block diagram of an electronic device 700 according to some embodiments of the present disclosure. The device 700 may be a device or apparatus described in the embodiments of the present disclosure. As shown in FIG. 7, the device 700 includes a central processing unit (CPU) and/or a graphics processing unit (GPU) 701, which may perform various suitable actions and processing according to computer program instructions stored in a read-only memory (ROM) 702 or computer program instructions loaded from a storage unit 708 into a random access memory (RAM) 703. The RAM 703 may also store various programs and data required for the operation of the device 700. The CPU/GPU 701, the ROM 702, and the RAM 703 are connected to one another through a bus 704. An input/output (I/O) interface 705 is also connected to the bus 704. Although not shown in FIG. 7, the device 700 may also include a coprocessor.

A plurality of components in the device 700 are connected to the I/O interface 705, including an input unit 706 such as a keyboard and a mouse; an output unit 707 such as various types of displays and speakers; the storage unit 708 such as a disk and an optical disk; and a communication unit 709 such as a network card, a modem, and a wireless communication transceiver. The communication unit 709 allows the device 700 to exchange information/data with other devices through a computer network such as the Internet, and/or various telecommunication networks.

The various methods or processes described above may be performed by the CPU/GPU 701. For example, in some embodiments, the method may be implemented as a computer software program that is tangibly included in a machine-readable medium, such as the storage unit 708. In some embodiments, part or all of the computer program may be loaded and/or installed onto the device 700 via the ROM 702 and/or the communication unit 709. When the computer program is loaded onto the RAM 703 and executed by the CPU/GPU 701, one or more of steps or actions of the methods or the processes described above may be performed.

In some embodiments, the methods and the processes described above may be implemented as a computer program product. The computer program product may include a computer-readable storage medium, carrying computer-readable program instructions for performing various aspects of the present disclosure.

The computer-readable storage medium may be a tangible device that may retain and store instructions used by an instruction-executing device. The computer-readable storage medium may be, for example, but is not limited to, an electric storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard drive, a random access memory (RAM), a read-only memory (ROM), an erasable programmable read-only memory (EPROM or a flash memory), a static random access memory (SRAM), a portable compact disk read-only memory (CD-ROM), a digital versatile disc (DVD), a memory stick, a floppy disk, a mechanical encoding device, such as a punch card or a raised structure in a groove with instructions stored therein, and any suitable combination of the above. The computer-readable storage medium used herein is not to be interpreted as transient signals, such as radio waves or other freely propagating electromagnetic waves, electromagnetic waves propagated through waveguides or other transmission media (e.g., light pulses through fiber-optic cables), or electrical signals transmitted through wires.

The computer-readable program instructions described herein may be downloaded from the computer-readable storage medium to various computing/processing devices or downloaded to an external computer or an external storage device through a network, such as the Internet, a local area network, a wide area network, and/or a wireless network. The network may include a copper transmission cable, optical fiber transmission, wireless transmission, a router, a firewall, a switch, a gateway computer, and/or an edge server. A network adapter card or a network interface in each computing/processing device receives the computer-readable program instructions from the network and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-dependent instructions, microcode, firmware instructions, state setting data, or source code or object code written in any combination of one or more programming languages, where the programming languages include object-oriented programming languages and conventional procedural programming languages. The computer-readable program instructions may be executed entirely on a user computer, partly on the user computer, as a stand-alone software package, partly on the user computer and partly on a remote computer, or entirely on the remote computer or the server. In the case of the remote computer, the remote computer may be connected to the user computer through any type of network, including a local area network (LAN) or a wide area network (WAN), or may be connected to the external computer (e.g., utilizing an Internet service provider for Internet connectivity). In some embodiments, an electronic circuit, such as a programmable logic circuit, a field programmable gate array (FPGA), or a programmable logic array (PLA), is customized by utilizing state information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or another programmable data processing apparatus, thereby producing a machine, such that these instructions, when executed by the processing unit of the computer or the another programmable data processing apparatus, produce an apparatus for implementing functions/actions specified in one or more blocks in the flowcharts and/or the block diagrams. These computer-readable program instructions may also be stored in the computer-readable storage medium, and these instructions cause the computer, the programmable data processing apparatus, and/or another device to operate in a specific method; and therefore, the computer-readable medium having instructions stored therein includes a product that includes instructions for implementing various aspects of the functions/actions specified in one or more blocks in the flowcharts and/or the block diagrams.

The computer-readable program instructions may also be loaded to the computer, the another programmable data processing apparatus, or the another device, such that a series of operating steps are performed on the computer, the another programmable data processing apparatus, or the another device to produce a computer-implemented process, and accordingly, the instructions executed on the computer, the another programmable data processing apparatus, or the another device implement the functions/actions specified in one or more blocks in the flowcharts and/or the block diagrams.

The flowcharts and the block diagrams in the accompanying drawings illustrate the possibly implemented system architectures, functions, and operations of the device, the method, and the computer program product according to the plurality of embodiments of the present disclosure. In this regard, each block in the flowcharts or the block diagrams may represent a module, a program segment, or a portion of instruction, and the module, the program segment, or the portion of instruction includes one or more executable instructions for implementing specified logical functions. In some alternative implementations, functions marked in the blocks may also occur in an order different from that marked in the accompanying drawings. For example, two successive blocks may actually be executed in parallel substantially, and sometimes may also be executed in a reverse order, depending on functions involved. It should be further noted that each block in the block diagrams and/or the flowcharts, as well as a combination of the blocks in the block diagrams and/or the flowcharts may be implemented by using a dedicated hardware-based system that executes specified functions or actions, or using a combination of dedicated hardware and computer instructions.

The embodiments of the present disclosure have been described above. The above-mentioned description is exemplary, rather than exhaustive, and is not limited to the disclosed various embodiments. Numerous modifications and variations are apparent to those of ordinary skill in the art without departing from the scope and spirit of the described embodiments. The selection of the terms as used herein is intended to best explain the principles and practical applications of the various embodiments, or technology improvements to technologies on the market, or to allow other persons of ordinary skill in the art to understand the various embodiments disclosed herein.

Some example implementations of the present disclosure are listed below.
Example 1. A method for editing audio content, including:
   determining an original acoustic feature of an original audio;
   acquiring a modified text, where the modified text includes an original portion identical to an original text of the original audio and a modified portion different from the original text;
   generating, based on the modified text and the original acoustic feature, a target acoustic feature corresponding to the modified portion of the modified text using a self-attention-based diffusion model; and
   generating a target audio based on the original acoustic feature and the target acoustic feature.
Example 2. The method according to Example 1, where generating, based on the modified text and the original acoustic feature, the target acoustic feature corresponding to the modified portion of the modified text using the self-attention-based diffusion model includes:
   generating a masked original acoustic feature by masking an acoustic feature in the original acoustic feature that corresponds to the modified portion; and
   generating the target acoustic feature based on the modified text, the original acoustic feature, and the masked original acoustic feature.
Example 3. The method according to Examples 1 to 2, where generating the target acoustic feature based on the modified text, the original acoustic feature, and the masked original acoustic feature includes:
   generating, based on the modified text, a modified text embedding using a text encoder;
   generating, based on global information of the original acoustic feature, a global timbre embedding using a global timbre encoder;
   generating, based on local information of the masked original acoustic feature, a local timbre embedding using a local timbre encoder; and
   generating the target acoustic feature based on the modified text embedding, the global timbre embedding, and the local timbre embedding.
Example 4. The method according to Examples 1 to 3, where generating, based on the global information of the original acoustic feature, the global timbre embedding using the global timbre encoder includes:

generating, based on the original acoustic feature, the global timbre embedding by using the global timbre encoder and taking the original acoustic feature as a whole in a time dimension.
Example 5. The method according to Examples 1 to 4, where generating, based on the local information of the masked original acoustic feature, the local timbre embedding using the local timbre encoder includes:
   splitting the masked original acoustic feature into a plurality of local acoustic features in a time dimension; and
   generating, based on the plurality of local acoustic features, the local timbre embedding using the local timbre encoder.
Example 6. The method according to Examples 1 to 5, where generating the target acoustic feature based on the modified text embedding, the global timbre embedding, and the local timbre embedding includes:
   generating a random noise;
   generating, based on the random noise, a noised acoustic embedding using a noised acoustic feature encoder;
   generating a fused acoustic embedding by summing the global timbre embedding, the local timbre embedding, and the noised acoustic embedding;
   generating a fused multimodal embedding by concatenating the fused acoustic embedding with the modified text embedding; and
   generating, based on the fused multimodal embedding, the target acoustic feature using the self-attention-based diffusion model.
Example 7. The method according to Examples 1 to 6, where generating, based on the fused multimodal embedding, the target acoustic feature using the self-attention-based diffusion model includes:
   generating, based on the fused multimodal embedding, a predicted acoustic feature using the self-attention-based diffusion model, where the predicted acoustic feature includes a predicted original portion corresponding to the original portion of the modified text and a predicted modified portion corresponding to the modified portion of the modified text; and
   determining the predicted modified portion as the target acoustic feature.
Example 8. The method according to Examples 1 to 7, where the self-attention-based diffusion model includes a plurality of self-attention blocks connected in series, and a portion of the plurality of self-attention blocks are connected to subsequent self-attention blocks that are spaced one or more self-attention blocks apart.
Example 9. The method according to Examples 1 to 8, where generating the target audio based on the original acoustic feature and the target acoustic feature includes:
   generating a modified original acoustic feature by replacing an acoustic feature in the original acoustic feature that corresponds to the modified portion of the modified text with the target acoustic feature; and
   generating the target audio based on the modified original acoustic feature, where an audio portion in the target audio corresponding to the original portion is the same as a corresponding audio portion in the original audio.
Example 10. The method according to Examples 1 to 9, where the target acoustic feature is generated using a self-attention-based diffusion model, and a training process of the self-attention-based diffusion model includes:
   determining a training acoustic feature of a training audio, where the training audio corresponds to a training text;
   generating a masked training acoustic feature by masking a portion of the training acoustic feature; and
   training the self-attention-based diffusion model based on the training text, the training acoustic feature, and the masked training acoustic feature.
Example 11. The method according to Examples 1 to 10, where training the self-attention-based diffusion model based on the training text, the training acoustic feature, and the masked training acoustic feature includes:
   generating a noised training acoustic feature by adding noise to the training acoustic feature;
   generating, based on the training text and the masked training acoustic feature, a predicted masked acoustic feature by denoising the noised training acoustic feature; and
   training the self-attention-based diffusion model based on the predicted masked acoustic feature and the training acoustic feature.
Example 12. The method according to Examples 1 to 11, where training the self-attention-based diffusion model based on the predicted masked acoustic feature and the training acoustic feature includes:
   extracting a true value of an acoustic feature of a masked portion from the training acoustic feature;
   determining a loss between the predicted masked acoustic feature and the true value; and
   training the self-attention-based diffusion model by minimizing a value of the loss.
Example 13. An apparatus for editing audio content, including:
   an original feature determination module, configured to determine an original acoustic feature of an original audio;
   a modified text acquiring module, configured to acquire a modified text, where the modified text includes an original portion identical to an original text of the original audio and a modified portion different from the original text;
   a target feature generation module, configured to generate, based on the modified text and the original acoustic feature, a target acoustic feature corresponding to the modified portion of the modified text using a self-attention-based diffusion model; and
   a target audio generation module, configured to generate a target audio based on the original acoustic feature and the target acoustic feature.
Example 14. The apparatus according to Example 13, where the target feature generation module includes:
   a masked feature generation module, configured to generate a masked original acoustic feature by masking an acoustic feature in the original acoustic feature that corresponds to the modified portion; and
   a masked feature use module, configured to generate the target acoustic feature based on the modified text, the original acoustic feature, and the masked original acoustic feature.
Example 15. The apparatus according to Examples 13 to 14, where the masked feature use module includes:
   a text embedding generation module, configured to generate, based on the modified text, a modified text embedding using a text encoder;
   a global embedding generation module, configured to generate, based on global information of the original acoustic feature, a global timbre embedding using a global timbre encoder;
   a local embedding generation module, configured to generate, based on local information of the masked original acoustic feature, a local timbre embedding using a local timbre encoder; and
   a text embedding use module, configured to generate the target acoustic feature based on the modified text embedding, the global timbre embedding, and the local timbre embedding.
Example 16. The apparatus according to Examples 13 to 15, where the global embedding generation module includes:
   a global encoder use module, configured to take, based on the original acoustic feature, the original acoustic feature as a whole to generate the global timbre embedding using the global timbre encoder in a time dimension.
Example 17. The apparatus according to Examples 13 to 16, where the local embedding generation module includes:
   a local feature generation module, configured to split the masked original acoustic feature into a plurality of local acoustic features in a time dimension; and
   a local feature use module, configured to generate, based on the plurality of local acoustic features, a local timbre embedding using a local timbre encoder.
Example 18. The apparatus according to Examples 13 to 17, where the text embedding use module includes:
   a random noise generation module, configured to generate a random noise;
   a noised embedding generation module, configured to generate, based on the random noise, a noised acoustic embedding using a noised acoustic feature encoder;
   a fused embedding generation module, configured to generate a fused acoustic embedding by summing the global timbre embedding, the local timbre embedding, and the noised acoustic embedding;
   a multimodal embedding generation module, configured to generate a fused multimodal embedding by concatenating the fused acoustic embedding with the modified text embedding; and
   a multimodal embedding use module, configured to generate, based on the fused multimodal embedding, the target acoustic feature using the self-attention-based diffusion model.
Example 19. The apparatus according to Examples 13 to 18, where the target feature generation module further includes:
   a predicted feature generation module, configured to generate, based on the fused multimodal embedding, a predicted acoustic feature using the self-attention-based diffusion model, where the predicted acoustic feature includes a predicted original portion corresponding to the original portion of the modified text and a predicted modified portion corresponding to the modified portion of the modified text; and
   a target feature determination module, configured to determine the predicted modified portion as the target acoustic feature.
Example 20. The apparatus according to Examples 13 to 19, where the self-attention-based diffusion model includes a plurality of self-attention blocks connected in series, and a portion of the plurality of self-attention blocks are connected to subsequent self-attention blocks that are spaced one or more self-attention blocks apart.
Example 21. The apparatus according to Examples 13 to 20, where the target audio generation module includes:
   an acoustic feature replacement module, configured to generate a modified original acoustic feature by replacing an acoustic feature in the original acoustic feature that corresponds to the modified portion of the modified text with the target acoustic feature; and
   a modified feature use module, configured to generate the target audio based on the modified original acoustic feature, where an audio portion in the target audio corresponding to the original portion is the same as a corresponding audio portion in the original audio.
Example 22. The apparatus according to Examples 13 to 21, where the target acoustic feature is generated using a self-attention-based diffusion model, and a training process of the self-attention-based diffusion model includes:
   a training feature determination module, configured to determine a training acoustic feature of a training audio, where the training audio corresponds to a training text;
   a training feature masking module, configured to generate a masked training acoustic feature by masking a portion of the training acoustic feature; and
   a diffusion model training module, configured to train the self-attention-based diffusion model based on the training text, the training acoustic feature, and the masked training acoustic feature.
Example 23. The apparatus according to Examples 13 to 22, where the diffusion model training module includes:
   a training feature noising module, configured to generate a noised training acoustic feature by adding noise to the training acoustic feature;
   a masking feature prediction module, configured to generate, based on the training text and the masked training acoustic feature, a predicted masked acoustic feature by denoising the noised training acoustic feature; and
   a predicted feature use module, configured to train the self-attention-based diffusion model based on the predicted masked acoustic feature and the training acoustic feature.
Example 24. The apparatus according to Examples 13 to 23, where the predicted feature use module includes:
   a true value extraction module, configured to extract a true value of an acoustic feature of a masked portion from the training acoustic feature;
   a loss determination module, configured to determine a loss between the predicted masked acoustic feature and the true value; and
   a loss minimizing module, configured to train the self-attention-based diffusion model by minimizing a value of the loss.
Example 25. An electronic device, including:
   a processor; and
   a memory coupled with the processor, where the memory has instructions stored therein, the instructions, when executed by the processor, cause the electronic device to perform actions, and the actions include:
   determining an original acoustic feature of an original audio;
   acquiring a modified text, where the modified text includes an original portion identical to an original text of the original audio and a modified portion different from the original text;
   generating, based on the modified text and the original acoustic feature, a target acoustic feature corresponding to the modified portion of the modified text using a self-attention-based diffusion model; and
   generating a target audio based on the original acoustic feature and the target acoustic feature.
Example 26. The device according to Example 25, where generating, based on the modified text and the original acoustic feature, the target acoustic feature corresponding to the modified portion of the modified text using the self-attention-based diffusion model includes:
   generating a masked original acoustic feature by masking an acoustic feature in the original acoustic feature that corresponds to the modified portion; and
   generating the target acoustic feature based on the modified text, the original acoustic feature, and the masked original acoustic feature.
Example 27. The device according to Examples 25 to 26, where generating the target acoustic feature based on the modified text, the original acoustic feature, and the masked original acoustic feature includes:
   generating, based on the modified text, a modified text embedding using a text encoder;
   generating, based on global information of the original acoustic feature, a global timbre embedding using a global timbre encoder;
   generating, based on local information of the masked original acoustic feature, a local timbre embedding using a local timbre encoder; and
   generating the target acoustic feature based on the modified text embedding, the global timbre embedding, and the local timbre embedding.
Example 28. The device according to Examples 25 to 27, where generating, based on the global information of the original acoustic feature, the global timbre embedding using the global timbre encoder includes:

generating, based on the original acoustic feature, the global timbre embedding by using the global timbre encoder and taking the original acoustic feature as a whole in a time dimension.
Example 29. The device according to Examples 25 to 28, where generating, based on the local information of the masked original acoustic feature, the local timbre embedding using the local timbre encoder includes:
   splitting the masked original acoustic feature into a plurality of local acoustic features in a time dimension; and
   generating, based on the plurality of local acoustic features, the local timbre embedding using the local timbre encoder.
Example 30. The device according to Examples 25 to 29, where generating the target acoustic feature based on the modified text embedding, the global timbre embedding, and the local timbre embedding includes:
   generating a random noise;
   generating, based on the random noise, a noised acoustic embedding using a noised acoustic feature encoder;
   generating a fused acoustic embedding by summing the global timbre embedding, the local timbre embedding, and the noised acoustic embedding;
   generating a fused multimodal embedding by concatenating the fused acoustic embedding with the modified text embedding; and
   generating, based on the fused multimodal embedding, the target acoustic feature using the self-attention-based diffusion model.
Example 31. The device according to Examples 25 to 30, where generating, based on the fused multimodal embedding, the target acoustic feature using the self-attention-based diffusion model includes:
   generating, based on the fused multimodal embedding, a predicted acoustic feature using the self-attention-based diffusion model, where the predicted acoustic feature includes a predicted original portion corresponding to the original portion of the modified text and a predicted modified portion corresponding to the modified portion of the modified text; and
   determining the predicted modified portion as the target acoustic feature.
Example 32. The device according to Examples 25 to 31, where the self-attention-based diffusion model includes a plurality of self-attention blocks connected in series, and a portion of the plurality of self-attention blocks are connected to subsequent self-attention blocks that are spaced one or more self-attention blocks apart.
Example 33. The device according to Examples 25 to 32, where generating the target audio based on the original acoustic feature and the target acoustic feature includes:
   generating a modified original acoustic feature by replacing an acoustic feature in the original acoustic feature that corresponds to the modified portion of the modified text with the target acoustic feature; and
   generating the target audio based on the modified original acoustic feature, where an audio portion in the target audio corresponding to the original portion is the same as a corresponding audio portion in the original audio.
Example 34. The device according to Examples 25 to 33, where the target acoustic feature is generated using a self-attention-based diffusion model, and a training process of the self-attention-based diffusion model includes:
   determining a training acoustic feature of a training audio, where the training audio corresponds to a training text;
   generating a masked training acoustic feature by masking a portion of the training acoustic feature; and
   training the self-attention-based diffusion model based on the training text, the training acoustic feature, and the masked training acoustic feature.
Example 35. The device according to Examples 25 to 34, where training the self-attention-based diffusion model based on the training text, the training acoustic feature, and the masked training acoustic feature includes:
   generating a noised training acoustic feature by adding noise to the training acoustic feature;
   generating, based on the training text and the masked training acoustic feature, a predicted masked acoustic feature by denoising the noised training acoustic feature; and
   training the self-attention-based diffusion model based on the predicted masked acoustic feature and the training acoustic feature.
Example 36. The device according to Examples 25 to 35, where training the self-attention-based diffusion model based on the predicted masked acoustic feature and the training acoustic feature includes:
   extracting a true value of an acoustic feature of a masked portion from the training acoustic feature;
   determining a loss between the predicted masked acoustic feature and the true value; and
   training the self-attention-based diffusion model by minimizing a value of the loss.
Example 37. A computer-readable storage medium, having computer-executable instructions stored therein, where the computer-executable instructions, when executed by a processor, implement the method according to any of Examples 1 to 12.
Example 38. A computer program product, where the computer program product is tangibly stored on a computer-readable medium and includes computer-executable instructions, and the computer-executable instructions, when executed by a device, cause the device to perform the method according to any of Examples 1 to 12.

Although the present disclosure has been described by adopting a language specific to structural features and/or method logical actions, it should be understood that the subject matter limited in the appended claims is not necessarily limited to the specific features or actions described above. On the contrary, the specific features and the actions described above are merely example forms for implementing the claims.

1. A method for editing audio content, comprising:
determining an original acoustic feature of an original audio;
acquiring a modified text, the modified text comprising an original portion identical to an original text of the original audio and a modified portion different from the original text;
generating, based on the modified text and the original acoustic feature, a target acoustic feature corresponding to the modified portion of the modified text using a self-attention-based diffusion model; and
generating a target audio based on the original acoustic feature and the target acoustic feature.

2. The method according to claim 1, wherein generating, based on the modified text and the original acoustic feature, the target acoustic feature corresponding to the modified portion of the modified text using the self-attention-based diffusion model comprises:
generating a masked original acoustic feature by masking an acoustic feature in the original acoustic feature that corresponds to the modified portion; and
generating the target acoustic feature based on the modified text, the original acoustic feature, and the masked original acoustic feature.

3. The method according to claim 2, wherein generating the target acoustic feature based on the modified text, the original acoustic feature, and the masked original acoustic feature comprises:
generating, based on the modified text, a modified text embedding using a text encoder;
generating, based on global information of the original acoustic feature, a global timbre embedding using a global timbre encoder;
generating, based on local information of the masked original acoustic feature, a local timbre embedding using a local timbre encoder; and
generating the target acoustic feature based on the modified text embedding, the global timbre embedding, and the local timbre embedding.

4. The method according to claim 3, wherein generating, based on the global information of the original acoustic feature, the global timbre embedding using the global timbre encoder comprises:
generating, based on the original acoustic feature, the global timbre embedding by using the global timbre encoder and taking the original acoustic feature as a whole in a time dimension.

5. The method according to claim 3, wherein generating, based on the local information of the masked original acoustic feature, the local timbre embedding using the local timbre encoder comprises:
splitting the masked original acoustic feature into a plurality of local acoustic features in a time dimension; and
generating, based on the plurality of local acoustic features, the local timbre embedding using the local timbre encoder.

6. The method according to claim 3, wherein generating the target acoustic feature based on the modified text embedding, the global timbre embedding, and the local timbre embedding comprises:
generating a random noise;
generating, based on the random noise, a noised acoustic embedding using a noised acoustic feature encoder;
generating a fused acoustic embedding by summing the global timbre embedding, the local timbre embedding, and the noised acoustic embedding;
generating a fused multimodal embedding by concatenating the fused acoustic embedding with the modified text embedding; and
generating, based on the fused multimodal embedding, the target acoustic feature using the self-attention-based diffusion model.

7. The method according to claim 6, wherein generating, based on the fused multimodal embedding, the target acoustic feature using the self-attention-based diffusion model comprises:
generating, based on the fused multimodal embedding, a predicted acoustic feature using the self-attention-based diffusion model, the predicted acoustic feature comprising a predicted original portion corresponding to the original portion of the modified text and a predicted modified portion corresponding to the modified portion of the modified text; and
determining the predicted modified portion as the target acoustic feature.

8. The method according to claim 1, wherein the self-attention-based diffusion model comprises a plurality of self-attention blocks connected in series, and a portion of the plurality of self-attention blocks are connected to subsequent self-attention blocks that are spaced one or more self-attention blocks apart.

9. The method according to claim 1, wherein generating the target audio based on the original acoustic feature and the target acoustic feature comprises:
generating a modified original acoustic feature by replacing an acoustic feature in the original acoustic feature that corresponds to the modified portion of the modified text with the target acoustic feature; and
generating the target audio based on the modified original acoustic feature, an audio portion in the target audio corresponding to the original portion being the same as a corresponding audio portion in the original audio.

10. The method according to claim 1, wherein a process of training the self-attention-based diffusion model comprises:
determining a training acoustic feature of a training audio, the training audio corresponding to a training text;
generating a masked training acoustic feature by masking a portion of the training acoustic feature; and
training the self-attention-based diffusion model based on the training text, the training acoustic feature, and the masked training acoustic feature.

11. The method according to claim 10, wherein training the self-attention-based diffusion model based on the training text, the training acoustic feature, and the masked training acoustic feature comprises:
generating a noised training acoustic feature by adding noise to the training acoustic feature;
generating, based on the training text and the masked training acoustic feature, a predicted masked acoustic feature by denoising the noised training acoustic feature; and
training the self-attention-based diffusion model based on the predicted masked acoustic feature and the training acoustic feature.

12. The method according to claim 11, wherein training the self-attention-based diffusion model based on the predicted masked acoustic feature and the training acoustic feature comprises:
extracting a true value of an acoustic feature of a masked portion from the training acoustic feature;
determining a loss between the predicted masked acoustic feature and the true value; and
training the self-attention-based diffusion model by minimizing a value of the loss.

13. An electronic device, comprising:
a processor; and
a memory coupled with the processor, wherein the memory has instructions stored therein, and the instructions, when executed by the processor, cause the electronic device to:
determine an original acoustic feature of an original audio;
acquire a modified text, the modified text comprising an original portion identical to an original text of the original audio and a modified portion different from the original text;
generate, based on the modified text and the original acoustic feature, a target acoustic feature corresponding to the modified portion of the modified text using a self-attention-based diffusion model; and
generate a target audio based on the original acoustic feature and the target acoustic feature.

14. The electronic device according to claim 13, wherein the instructions causing the electronic device to generate, based on the modified text and the original acoustic feature, the target acoustic feature corresponding to the modified portion of the modified text using the self-attention-based diffusion model comprise instructions causing the electronic device to:
generate a masked original acoustic feature by masking an acoustic feature in the original acoustic feature that corresponds to the modified portion; and
generate the target acoustic feature based on the modified text, the original acoustic feature, and the masked original acoustic feature.

15. The electronic device according to claim 14, wherein the instructions causing the electronic device to generating the target acoustic feature based on the modified text, the original acoustic feature, and the masked original acoustic feature comprise instructions causing the electronic device to:
generate, based on the modified text, a modified text embedding using a text encoder;
generate, based on global information of the original acoustic feature, a global timbre embedding using a global timbre encoder;
generate, based on local information of the masked original acoustic feature, a local timbre embedding using a local timbre encoder; and
generate the target acoustic feature based on the modified text embedding, the global timbre embedding, and the local timbre embedding.

16. The electronic device according to claim 15, wherein the instructions causing the electronic device to generate, based on the global information of the original acoustic feature, the global timbre embedding using the global timbre encoder comprise instructions causing the electronic device to:
generate, based on the original acoustic feature, the global timbre embedding by using the global timbre encoder and taking the original acoustic feature as a whole in a time dimension.

17. The electronic device according to claim 15, wherein the instructions causing the electronic device to generate, based on the local information of the masked original acoustic feature, the local timbre embedding using the local timbre encoder comprise instructions causing the electronic device to:
split the masked original acoustic feature into a plurality of local acoustic features in a time dimension; and
generate, based on the plurality of local acoustic features, the local timbre embedding using the local timbre encoder.

18. The electronic device according to claim 15, wherein the instructions causing the electronic device to generate the target acoustic feature based on the modified text embedding, the global timbre embedding, and the local timbre embedding comprise instructions causing the electronic device to:
generate a random noise;
generate, based on the random noise, a noised acoustic embedding using a noised acoustic feature encoder;
generate a fused acoustic embedding by summing the global timbre embedding, the local timbre embedding, and the noised acoustic embedding;
generate a fused multimodal embedding by concatenating the fused acoustic embedding with the modified text embedding; and
generate, based on the fused multimodal embedding, the target acoustic feature using the self-attention-based diffusion model.

19. The electronic device according to claim 18, wherein the instructions causing the electronic device to generate, based on the fused multimodal embedding, the target acoustic feature using the self-attention-based diffusion model comprise instructions causing the electronic device to:
generate, based on the fused multimodal embedding, a predicted acoustic feature using the self-attention-based diffusion model, the predicted acoustic feature comprising a predicted original portion corresponding to the original portion of the modified text and a predicted modified portion corresponding to the modified portion of the modified text; and
determine the predicted modified portion as the target acoustic feature.

20. A computer program product, comprising computer-executable instructions, wherein the computer-executable instructions, when executed by a processor, cause an electronic device to:
determine an original acoustic feature of an original audio;
acquire a modified text, the modified text comprising an original portion identical to an original text of the original audio and a modified portion different from the original text;
generate, based on the modified text and the original acoustic feature, a target acoustic feature corresponding to the modified portion of the modified text using a self-attention-based diffusion model; and
generate a target audio based on the original acoustic feature and the target acoustic feature.
